(19) United States
(12) Patent Application Publication
(10) Pub. No.: US 2006/0222914 A1
(43) Pub. Date: Oct. 5, 2006

(54) FUEL CELL CARTRIDGE AND FUEL CELL SYSTEM

(75) Inventors: Kazuhiro YASUDA, Yokohama-shi (JP); Yoshihiko NAKANO, Yokohama-shi (JP); Hideyuki OHZU, Yokohama-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/277,584

(22) Filed: Mar. 27, 2006

(30) Foreign Application Priority Data
Mar. 31, 2005 (JP) 2005-105174

(51) Int. Cl. H01M 8/04; G06F 19/00

(52) U.S. Cl. 429/22; 702/25

(57) ABSTRACT

A fuel cell cartridge filled with liquid fuel includes a warning mechanism including a detector to detect a concentration of metal ions in the liquid fuel and a comparator to compare the concentration of metal ions with a predetermined value, and issuing a warning when the concentration of the metal ions exceeds the predetermined value.

### CROSS REFERENCE TO RELATED APPLICATIONS

This application is based upon and claims the benefit of priority from the prior Japanese Patent Application No. 2005-105174 filed on Mar. 31, 2005, the entire contents of which are incorporated herein by reference.

### BACKGROUND OF THE INVENTION

1. Field of the Invention

The present invention relates to a fuel cell cartridge, as well as to a fuel cell system.

2. Description of the Related Art

A fuel cell using liquid fuel has attracted attention as a power source for a mobile electrical apparatus, such as a small portable apparatus or a PC, and extensive development and studies have been conducted on such a fuel cell. In particular, a fuel cell of a type which sequentially supplies high-concentration methanol stored in a cartridge tank, and which uses methanol while diluting the high-concentration methanol in its fuel cell system is advantageously convenient, in view of being capable of supplying fuel inexpensively and readily.

However, in a fuel cell of this type which directly supplies liquid fuel, such as methanol, to an electrode, the liquid fuel is lowered in pH by formic acid or carbon dioxide produced during reaction in the anode electrode, thereby causing elution of a trace amount of metal ions from a member being employed (see JP-A-2004-79210). Particularly in a fuel cell system which dilutes high-concentration fuel with water produced in power generation, to thus be activated for a long term, pH of the circulating liquid fuel drastically drops. As a result, such a phenomenon occurs within a short period of time. In addition, in some cases, metal ions intrude into the system from the outside during air intake, or from the outside of a unit during replacement of a fuel cartridge. These metal ions derived from the inside and/or outside of the system are accumulated in a cell, and cause a phenomenon of degradation of cell performance is within a short period of time. More specifically, when the liquid fuel within the unit is lowered in pH as described above, a constituent member in the system is brought into contact with the liquid of low pH, and elution of a trace amount of metal ions occurs. Meanwhile, air to be taken from the outside as an oxidant gas also includes a trace amount of impurities. Hence, metal ions in the impurities leach into the unit. These metal ions derived from the inside and the outside of the unit are accumulated on the cell, chiefly an ionic conductive member, thereby degrading performance of the cell. The fuel cell disclosed in JP-A-2004-79210 employs an absorbent, such as activated carbon, a photocatalyst, an ion exchange resin, or the like, as a filter for absorbing these metal ions, and the like.

Metal ions are sometimes mixed into the fuel inside a cartridge, which is one of the sources of above-described metal ions, during preparation of the fuel or, depending on conditions, after the cartridge has been filled. In a case where the fuel inside the cartridge and a constituent member of the cartridge are brought into contact each other for a long period of time, metal ions are eluted into the fuel from a catalyst used for synthesis of the constituent member (a member primarily formed from plastics) and/or from a component employed as an additive component. Provision of an ion-exchange resin, or the like, which absorbs these metal ions in advance inside the cartridge in order to suppress the elution is effective. Although there are some cases, such as during long-term storage, where ions are eluted in such a high concentration as to exceed an allowable level, no means has been provided for immediately informing a user to this effect, and this has become a factor for significantly shortening a useful life of a fuel cell system. In addition to the foregoing degradation by the supply of the metal ions mixed from the cartridge into the system, there are other causes for degradation of a fuel cell system. However, no means has been provided for preventing the mixing of the metal ions from the cartridge.

The related-art fuel cell system involves a problem that metal ions having been mixed into fuel from a cartridge degrade an ion exchange resin, or the like, serving as a fuel cell, thereby shortening a useful life of the fuel cell.

The present invention has been conceived in view of the problem, and aims at providing a fuel cell system being capable of preventing supply of fuel, into which metal ions are mixed from a cartridge, to the fuel cell system, thereby preventing breakage which may otherwise be caused by the metal ions present inside the cartridge.

### SUMMARY OF THE INVENTION

According to an aspect of the present invention, a fuel cell cartridge filled with liquid fuel includes a warning mechanism including a detector to detect a concentration of metal ions in the liquid fuel and a comparator to compare the concentration of metal ions with a predetermined value, and issuing a warning when the concentration of the metal ions exceeds the predetermined value.

According to another aspect of the present invention, a fuel cell system includes a fuel cell cartridge filled with liquid fuel, and a fuel cell configured to receive supply of the liquid fuel from the fuel cell cartridge, to be activated. The fuel cell cartridge includes a warning mechanism including a detector to detect a concentration of metal ions in the liquid fuel and a comparator to compare the concentration of metal ions with a predetermined value, and issuing a warning when the concentration of the metal ions exceeds the predetermined value.

According to another aspect of the present invention, a fuel cell system includes a fuel cell cartridge filled with liquid fuel, a fuel cell configured to receive supply of liquid fuel from the fuel cell cartridge, to be activated, and a warning mechanism including a detector to detect a concentration of metal ions in the liquid fuel and a comparator to compare the concentration of metal ions with a predetermined value, and issuing a warning when the concentration of the metal ions exceeds the predetermined value.

### BRIEF DESCRIPTION OF THE DRAWINGS

FIG. 1 shows a configuration of a cartridge member of Example 1 of the invention;

FIG. 2 is a cross-sectional view of the cartridge member of Example 1 of the invention;

FIG. 3 is a cross-sectional view of a cartridge member of Example 2 of the invention;

FIG. 4 shows a configuration of a unit member of Example 3 of the invention;

FIG. 5 is a cross-sectional view of a unit member of Example 6 of the invention;

FIG. 6 is a cross-sectional view of a cartridge member of Example 4 of the invention;

FIG. 7 is a cross-sectional view of a unit member of each of Example 5 and 6 of the invention;

FIG. 8 is a cross-sectional view of a cartridge member of Example 7 of the invention;

FIG. 9 is a cross-sectional view of a cartridge member of Example 8 of the invention; and

FIG. 10 is a cross-sectional view of a cartridge member of Example 9 of the invention.

### DETAILED DESCRIPTION OF THE INVENTION

Hereinafter, configurations intended for the foregoing claims will be described more specifically and in detail along with their effects, objects, and the like.

The present invention provides a fuel cell system. The fuel cell system determines, prior to or immediately after its use, a metal ion concentration in liquid fuel supplied from a cartridge; and issues a visual alarm, an audible alarm, or a like alarm to a user when the metal ions are contained in a predetermined amount or more (measurement per se is preferably performed on the metal ion concentration since, in this case, processing and handling, which are performed subsequent to the measurement, of measured values can be performed readily).

In addition, a user is notified of whether or not the metal ion concentration in the liquid fuel inside the cartridge has exceeded the predetermined concentration, visually or in an auditory manner, by means of determining a concentration through use of (1) chemical reaction between the metal ions and a chemical substance and (2) measurement of electric conductivity.

Examples of a technique to be employed for visual ascertainment of the metal ion concentration in the fuel supplied from the cartridge include a method which uses an indicator (e.g., EBT: eriochrome black T; or an NN indicator), thereby utilizing color change which occurs when metal ions are mixed inside a unit.

Coloration by means of the chemical reaction is as follows. Under absence of metal ions, EBT exhibits its original color (blue). However, when fuel in which metal ions are present is added thereto, EBT and the metal ions form complexes by chemical reaction. Accordingly, the color is changed to that of the complexes (red). By means of utilizing this phenomenon, a metal ion concentration in fuel inside the cartridge can be determined visually.

Meanwhile, with regard to the conductivity of liquid containing metal ions, when the metal ions are contained as impurities in an amount of 100 ppb or more, the conductivity of the liquid becomes 1 μS/cm or more. Hence, the present invention utilizes this principle, and readily measures a concentration of the metal ions in the fuel, and provides a notification to a user visually (displaying the conductivity, an ion concentration calculated therefrom, and TDS (total dissolved solids); and providing a warning display in accordance with the values), or in an audible manner (issuing a warning sound, or the like, when a result of processing with regard to data obtained by measurement of the conductivity exceeds a given value). The warning sound is issued by using a mechanism which amplifies a signal obtained by measurement of conductivity in another circuit, and issues the same.

The conductivity is to be measured in accordance with a general measurement method; that is, with use of an electrode, such as a glass electrode. The electrode is to be installed either in the unit or in the fuel cartridge, depending on a space for storage or a power supply method. The measurement is performed for ascertainment as to whether or not the fuel is in an appropriate condition for usage. At the time of attachment of the cartridge, the conductivity is measured by means of pulling a predetermined amount of the fuel into the unit; and the same is measured within the cartridge as required. When the thus-re-measured value is ascertained to satisfy a predetermined condition (i.e, 1 μS/cm or lower, which is the concentration of the predetermined value having been converted into conductivity), actual fuel supply into the unit is enabled. In a case where the above condition is not satisfied, a user is informed of the abnormal condition by visual or audible means.

A mechanism for providing the visual display, the warning sound, or the like, maybe mounted either in the power generation unit or in a cartridge main body. However, a display method other than the coloration with use of chemical reaction, or issuance of a warning sound, requires an external power source. Therefore, installation within the power generation unit is more desirable. Alternatively, a signal for causing display or issuance of a warning sound maybe sent to inside an electrical apparatus, which consumes electric power independently from the power generation unit and the cartridge, thereby informing a user of normality/abnormality of the fuel cartridge.

The conductivity of the fuel within the cartridge may be measured by means of (1) pulling a predetermined amount of is the fuel in the cartridge into the unit at the time of attachment of the cartridge to the power generation unit, and measuring the conductivity of the fuel (the amount of metal ions is determined from the conductivity); (2) placing an electrode section for use in measurement of the conductivity directly into the cartridge at the time of attachment, thereby measuring the conductivity; or (3) measuring the conductivity of fuel stored in another chamber within the cartridge. Alternatively, independently from the above, when a fuel cell system is configured such that an electrode for use in measurement of conductivity is incorporated within the cartridge, (4) the electrode for use in measurement of conductivity may be placed directly in a container where the fuel is stored; or (5) the conductivity may be measured in another chamber, where the electrode for measurement of conductivity is incorporated, by means of pulling-in the fuel to the chamber immediately prior to use. Meanwhile, in the case where the electrode for use in measurement of conductivity is incorporated within the cartridge as in the case of (4) or (5), a power source (such as a button battery) for use in measurement is preferably provided within the cartridge, so that the metal ion concentration in the fuel can be ascertained before usage. In this case, it may be the case that only the measured value of the conductivity is displayed; or only availability of the power source is displayed (in the form of character string display or with use of one or more LEDs) on the basis of comparison between the measured value and a predetermined value; or notification may be provided to a user by means of a warning sound, or the like. Among the above, employment of method (1) or (3) is preferable, in view of simplification of the mechanism, and employment of method (1) is further preferable, in view that the mechanism becomes convenient. Meanwhile, employment of method (4) or (5) is preferable, in view of suppressing degradation of performance of the power generation unit so that the condition of the fuel can be ascertained before the cartridge is actually attached to the unit and used.

Hereinafter, specific examples of the invention will be described by reference to examples.

### EXAMPLE 1

(Display on Cartridge and Cartridge Power Source)

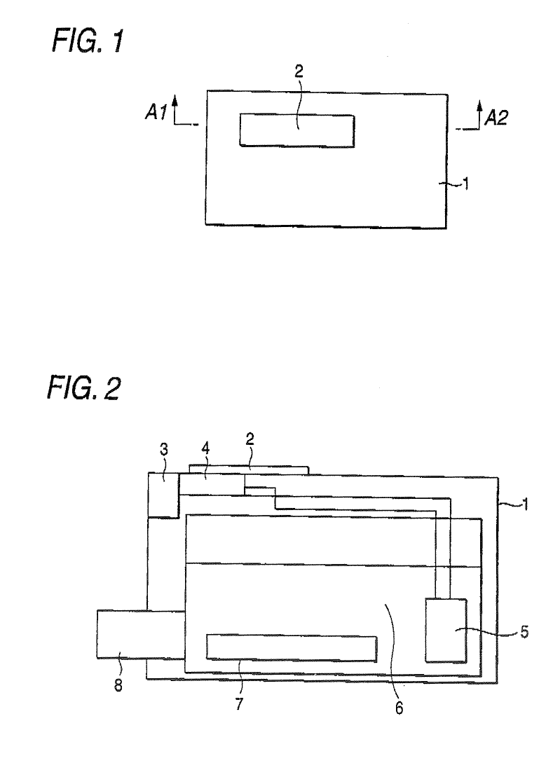

A fuel cell system comprises a fuel cell unit formed from a stack 18, a fuel/air supply system 17, a liquid (water) circulation system 14, a system control system, a fuel circulation system 13, and the like; and a fuel cartridge in which liquid fuel is filled. As illustrated in FIG. 1, the fuel cell system has a display section 2 for displaying a message in accordance with a value obtained by measurement of a metal ion concentration in fuel within a cartridge 1. The display section 2 is, for instance, a liquid display device.

FIG. 2 illustrates across-section of the cartridge (taken along a line A1-A2 of FIG. 1). A calculation unit 4 can calculate an amount of sampled metal ions. In addition, the calculation unit 4 includes a comparator (not shown) to compare the amount of the sampled metal ions (having been converted from a concentration into an amount) with a predetermined value (an amount of ions corresponding to a sufficient ion concentration to degrade an ion exchange member 7 or more) having been prepared in advance; and output, when the sampled amount exceeds the foregoing predetermined value, a warning to this effect is provided as an electrical signal to the display section 2. The display section 2 is configured so as to display a “warning” upon receipt of the electrical signal. The display section may either perform the display in the form of a character string, or notify the condition of the fuel by means of disposing LEDs in the vicinities of notations of “good,” “normal,” “abnormal,” “warning,” and the like. Alternatively, identification among “normal,” “abnormal,” or “warning” may be informed to a user simply by means of a color of an LED, As illustrated in FIG. 2, an electrode 5 for measuring ion conductivity is inserted directly into fuel within the cartridge. After the ion conductivity is measured and processed by the calculation unit 4, a message is written in the display section 2. Electric power is supplied from an external power source 3 within the cartridge. That is, the ion exchange member 7 maybe positioned inside the cartridge 1 as illustrated in FIG. 2. A joint 8 is a section via which connection with a fuel cell main body is established, and from which fuel inside the cartridge 1 is to be supplied to the fuel cell main body.

A continuous power generation test was performed with use of the fuel cartridge 1 hating the above configuration. After the display on the surface of the cartridge was ascertained not to be indicating “abnormal,” the fuel cartridge was attached to the fuel cell unit, and thereafter an electrical apparatus, such as a PC, was activated.

During use of the fuel cartridge, no great change was observed in the power generation performance, and a stable output was obtained. Conductivity of the remaining fuel inside the fuel cartridge was measured and found to be 1 μS/cm or less; and the metal ion concentration was measured by means of inductively coupled plasma spectrometry and found to be 100 ppb or less.

The fuel cartridge having the above shape was operated for about 2,000 hours. However, in a case where a fuel cartridge with a display not indicating “abnormal” was used, no drastic reduction in power generation performance was observed.

### EXAMPLE 2

A fuel cell system comprises a fuel cell unit formed from a stack, a fuel/air supply system, a liquid (water) and fuel circulation system, a system control system, and the like; and a fuel cartridge in which liquid fuel is filled. The fuel cell system has a portion for displaying a message in accordance with a value obtained by measurement of a metal ion concentration in fuel within the cartridge as in the case of FIG. 1. In descriptions about the following examples, identical elements are denoted by the same reference numerals, and repeated descriptions are omitted.

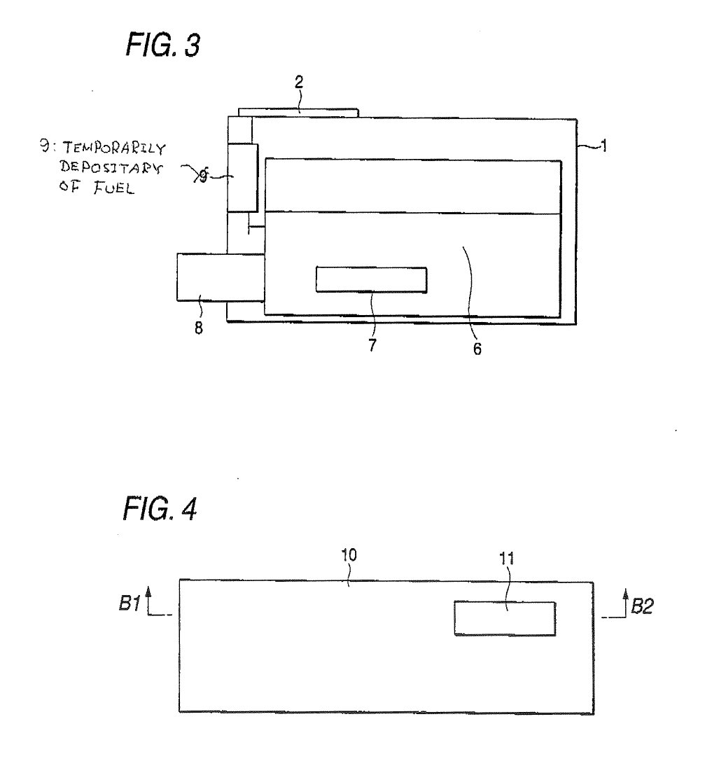

FIG. 3 illustrates a cross-section of the cartridge (a plan view thereof is the same as that of FIG. 1, and taken along the line A1-A2). As illustrated in FIG. 3, the display section 2 has a portion (a temporarily depositary of fuel 9) for storing fuel inside the cartridge. An indicator which reacts with liquid containing metal ions, thereby changing its color, e.g., EST (eriochrome black T), is stored in the storage section. The cartridge is configured so that the fuel is supplied to the storage section from the cartridge prior to use; the indicator immediately reacts with the metal ions in the fuel; and, when the fuel contains the metal ions in an amount of the predetermined value or more, a user can visually ascertain the color of the storage section. A continuous power generation test was performed with use of the fuel cartridge having the above configuration. After the display on the surface of the cartridge was ascertained to be showing blue (red is shown when the condition is abnormal), the fuel cartridge was attached to the fuel cell unit, and thereafter an electrical apparatus, such as a PC, was activated.

During use of the fuel cartridge, no great change was observed in the power generation performance, and a stable output was obtained. Conductivity of the remaining fuel inside the fuel cartridge was measured and found to be 1 μS/cm or less; and the metal ion concentration was measured by means of inductively coupled plasma spectrometry and found to be 100 ppb or less.

The fuel cartridge having the above shape was operated for about 2,000 hours. However, in a case where a fuel cartridge with a display not indicating “abnormal” was used, no drastic reduction in power generation performance was observed.

### EXAMPLE 3

(Display on Unit, Unit Power Source)

A fuel cell system comprises a fuel cell unit formed from a stack, a fuel/air supply system, a liquid (water) and fuel circulation system, a system control system, and the like; and a fuel cartridge in which liquid fuel is filled. As illustrated in FIG. 4, the fuel cell system is configured such that a metal ion concentration in the fuel is measured, and a message is displayed on a unit display section 11 in accordance with the thus-measured value.

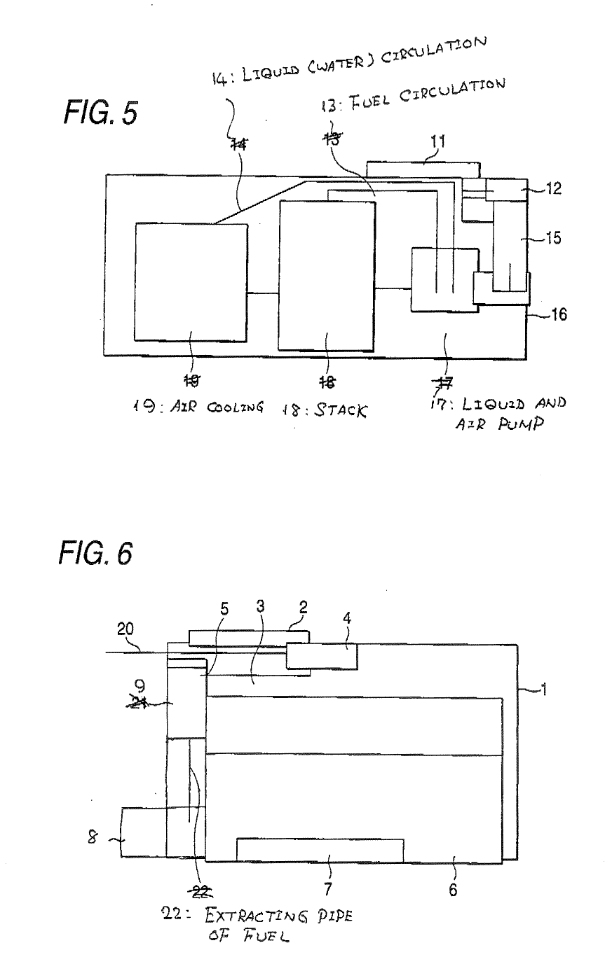

FIG. 5 illustrates a cross-sectional view of a unit 10 (taken along a line B1-B2 of FIG. 4). As illustrated in FIG. 5, a temporarily depositary of fuel 15 for performing measurement of a concentration of the fuel in the unit section is provided, and configured such that a predetermined amount of fuel is supplied thereto at the time of attachment of the cartridge. An electrode for measuring the metal ion concentration in the fuel is inserted into the storage section 15. Ion conductivity thereof is measured, and written in the display section 11 after having been processed by a power source and calculation section 12 (the electric power is supplied from a power source within the unit).

A continuous power generation test was performed with use of the fuel cartridge having the above configuration. After the display on the surface of the cartridge was ascertained not to be indicating “abnormal,” the fuel cartridge was attached to the fuel cell unit, and thereafter an electrical apparatus, such as a PC, was activated.

During use of the fuel cartridge, no great change was observed in the power generation performance, and a stable output was obtained. Conductivity of the remaining fuel inside the fuel cartridge was measured and found to be 1 μS/cm or less; and the metal ion concentration was measured by means of inductively coupled plasma spectrometry and found to be 100 ppb or less.

The fuel cartridge having the above shape was operated for about 2,000 hours. However, in a case where a fuel cartridge with a display not indicating “abnormal” was used, no drastic reduction in power generation performance was observed.

### EXAMPLE 4

(Display on Cartridge, Unit Power Source)

A fuel cell system comprises a fuel cell unit formed from a stack, a fuel/air supply system, a liquid (water) and fuel circulation system, a system control system, and the like; and a fuel cartridge in which liquid fuel is filled. As illustrated in FIG. 1, the fuel cell system has a portion for displaying a message in accordance with a value obtained by measurement of a metal ion concentration in fuel within the cartridge.

FIG. 6 illustrates a cross-section of the cartridge. As illustrated in FIG. 6, the electrode 5 for measuring the ion conductivity is inserted directly into fuel within the cartridge. After ion conductivity of the fuel is measured, a message is written in the display section after having been processed by the calculation unit 4. In addition, there is adopted such a configuration that measurement of the conductivity is started with use of electric power supplied from inside the power generation unit when the cartridge is attached to the unit.

A continuous power generation test was performed with use of the fuel cartridge having the above configuration. After the display on the surface of the cartridge was ascertained not to be indicating “abnormal,” the fuel cartridge was attached to the fuel cell unit, and thereafter an electrical apparatus, such as a PC, was activated.

During use of the fuel cartridge, no great change was observed in the power generation performance, and a stable output was obtained. Conductivity of the remaining fuel inside the fuel cartridge was measured and found to be 1 μS/cm or less; and the metal ion concentration was measured by means of inductively coupled plasma spectrometry and found to be 80 ppb or less.

The fuel cartridge having the above shape was operated for about 2,000 hours. However, in a case where a fuel cartridge with a display not indicating “abnormal” was used, no drastic reduction in power generation performance was observed.

### EXAMPLE 5

(Display on Unit, Unit Power Source, And Warning Sound)

A fuel cell system comprises a fuel cell unit formed from a stack, a fuel/air supply system, a liquid (water) and fuel circulation system, a system control system, and the like; and a fuel cartridge in which liquid fuel is filled. As illustrated in FIG. 4, the fuel cell system has a portion for displaying a message on the surface of the unit in accordance with a value obtained by measurement of a metal ion concentration in fuel.

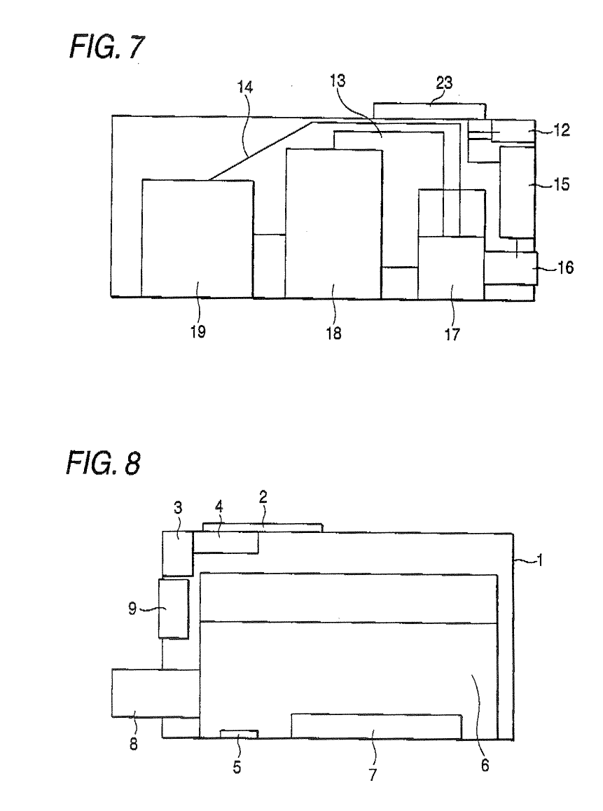

FIG. 7 illustrates a cross-sectional view of the unit 10. As illustrated in FIG. 7, a fuel concentration measurement section of the unit section is provided, and configured such that a predetermined amount of fuel is supplied thereto at the time of attachment of the cartridge. The electrode for measuring the metal ion concentration in the fuel is inserted into the fuel concentration measurement section which has an alarm issuance section 23. The alarm issuance section 23 measures ion conductivity of the fuel, and subjects the data on the measurement result to processing by the calculation unit 12, and notifies a user about normality or abnormality of the fuel in an auditory manner (during a normal time, an intermittent sound is issued for three seconds, and during an abnormal time, a continuous sound is issued for 60 seconds; and the electric power is supplied from a power source within the unit).

A continuous power generation was performed with use of the fuel cartridge having the above configuration. After a normal sound was ascertained to have been issued at the time when the cartridge was attached to the unit, the fuel cartridge was attached to the fuel cell unit, and thereafter an electrical apparatus, such as a PC, was activated.

During use of the fuel cartridge, no great change was observed in power generation performance, and a stable output was obtained.

After power generation as described above was performed for about 100 hours, fuel whose warranty period had expired was attached to the power generation unit intentionally.

Issuance of a continuous sound for notifying of abnormality was ascertained at the time of attachment. However, in defiance of the sound, power was caused to generate, and the electrical apparatus was continued to use. When the electrical apparatus was activated by a unit by which power had been generated through use of the fuel, power generation performance gradually degraded, and in less than five hours fell short of sufficient power generation performance to activate the apparatus.

Conductivity of the remaining fuel inside the fuel cartridge was measured and found to be 500 μS/cm or more; and metal ion concentration was measured by means of inductively coupled plasma spectrometry and found to be 1 ppm or less.

### EXAMPLE 6

A fuel cell system comprises a fuel cell unit formed from a stack, a fuel/air supply system, a liquid (water) and fuel circulation system, a system control system, and the like; and a fuel cartridge in which liquid fuel is filled. As illustrated in FIG. 1, the fuel cell system is arranged such that liquid which changes its color in accordance with a metal ion concentration in fuel within the cartridge can be visually checked from the outside. FIG. 8 illustrates a cross-section of the cartridge. As illustrated in FIG. 8, a display section has a portion for storing fuel inside the cartridge. An indicator which reacts with liquid containing metal ions, thereby changing its color; e.g., EBT (eriochrome black T), is stored in the storage section. The cartridge is configured so that the fuel is supplied to the storage section from the cartridge prior to use; the indicator immediately reacts with the metal ions in the fuel; and, when the fuel contains the metal ions in an amount of the predetermined value or more, a user can visually ascertain the color of the storage sections A continuous power generation test was performed with use of the fuel cartridge having the above configuration. After the display on the surface of the cartridge was ascertained to be showing blue (red is shown when the condition is abnormal), the fuel cartridge was attached to the fuel cell unit, and thereafter an electrical apparatus, such as a PC, was activated.

After power generation as described above was performed for about 100 hours, fuel whose warranty period had expired was attached to the power generation unit by mistake.

The liquid of the display section was ascertained to have changed its color from blue to red at the time when the cartridge was attached to the unit. However, subsequent to attachment of the cartridge to the fuel cell unit, an electrical apparatus, such as a PC, was activated.

When the electrical apparatus was activated by a unit by which power had been generated through use of the fuel, the power generation performance gradually degraded, and in less than five hours fell short of sufficient power generation performance enough to activate the apparatus.

Conductivity of the remaining fuel inside the fuel cartridge was measured and found to be 10 mS/cm or more; and metal ion concentration was measured by means of inductively coupled plasma spectrometry and found to be 10 ppm or less.

### EXAMPLE 7

A fuel cell system comprises a fuel cell unit formed from a stack, a fuel/air supply system, a liquid (water) and fuel circulation system, a system control system, and the like; and a fuel cartridge 1 in which liquid fuel is filled. As illustrated in FIG. 1, the fuel cell system has the display section 2 for displaying a message in accordance with a value obtained by measurement of a metal ion concentration in fuel within the cartridge.

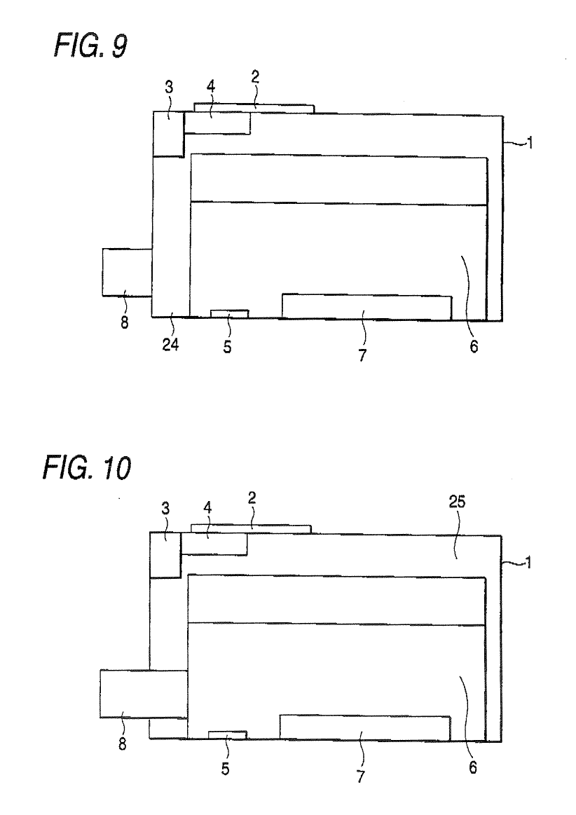

FIG. 9 illustrates a cross-section of the cartridge. As illustrated in FIG. 9, the electrode 5 for measuring ion conductivity is inserted directly into fuel within the cartridge. After the ion conductivity is measured and processed by the calculation unit 4, a message is written in the foregoing display section 2 (electric power is supplied from the external power source 3 within the cartridge). The electrode 5 is disposed in the vicinity of the joint 8 between the cartridge and the unit. The ion exchange member 7 may be positioned inside the cartridge 1 as illustrated in FIG. 9. Meanwhile, the example illustrated in FIG. 9 employs a flat electrode as an electrode for measuring the conductivity.

A continuous power generation test was performed with use of the fuel cartridge having the above configuration. After display on the surface of the cartridge was ascertained not to be indicating “abnormal,” the fuel cartridge was attached to the fuel cell unit, and thereafter an electrical apparatus, such as a PC, was activated.

During use of the fuel cartridge, no great change was observed in the power generation performance, and a stable output was obtained. Conductivity of the remaining fuel inside the fuel cartridge was measured and found to be 1 μS/cm or less; and metal ion concentration was measured by means of inductively coupled plasma spectrometry and found to be 100 ppb or less.

The fuel cartridge having the above shape was operated for about 2,000 hours. However, in a case where a fuel cartridge with a display not indicating “abnormal” was used, no drastic reduction in power generation performance was observed.

### EXAMPLE 8

A fuel cell system comprises a fuel cell unit formed from a stack, a fuel/air supply system, a liquid (water) and fuel circulation system, a system control system, and the like; and a fuel cartridge 1 in which liquid fuel is filled. As illustrated in FIG. 1, the fuel cell system has the display section 2 for displaying a message in accordance with a value obtained by measurement of a metal ion concentration in fuel within the cartridge.

FIG. 9 illustrates a cross-section of the cartridge. As illustrated in FIG. 9, the flat electrode 5 (made of glass) for measuring ion conductivity is inserted directly into fuel within the cartridge. After ion conductivity is measured and processed by the calculation unit 4, a message is written in the display section 2. (The electric power is supplied from the external power source 3 within the cartridge.) The electrode 5 is disposed in the vicinity of a joint section between the cartridge and the unit. The ion exchange member 7 may be positioned inside the cartridge 1 as illustrated in FIG. 9. In addition, the example illustrated in FIG. 9 has an oxygen absorbent 24 for suppressing generation of acids which inhibit conductivity in the fuel.

A continuous power generation test was performed with use of the fuel cartridge having the above configuration. After display on the surface of the cartridge was ascertained not to be indicating “abnormal,” the fuel cartridge was attached to the fuel cell unit, and thereafter an electrical apparatus, such as a PC, was activated.

During use of the fuel cartridge, no great change was observed in power generation performance, and a stable output was obtained. Conductivity of the remaining fuel inside the fuel cartridge was measured and found to be 1 μS/cm or less; and metal ion concentration was measured by means of inductively coupled plasma spectrometry and found to be 100 ppb or less.

The fuel cartridge having the above shape was operated for about 2,500 hours. However, in a case where a fuel cartridge with a display not indicating “abnormal” was used, no drastic reduction in power generation performance was observed.

### EXAMPLE 9

A fuel cell system comprises a fuel cell unit formed from a stack, a fuel/air supply system, a liquid (water) and fuel circulation system, a system control system, and the like; and a fuel cartridge 1 in which liquid fuel is filled. As illustrated in FIG. 1, the fuel cell system has the display section 2 for displaying a message in accordance with a value obtained by measurement of a metal ion concentration in fuel within the cartridge.

FIG. 10 illustrates a cross-section of the cartridge. As illustrated in FIG. 10, the flat electrode 5 (made of glass) for measuring ion conductivity is inserted directly into fuel within the cartridge. After ion conductivity is measured and processed by the calculation unit 4, a message is written in the display section 2. (The electric power is supplied from the external power source 5 within the cartridge.) The electrode 3 is disposed in the vicinity of a joint section between the cartridge and the unit. The ion exchange member 7 may be positioned inside the cartridge 1 as illustrated in FIG. 9. In addition, in the example illustrated in FIG. 10, nitrogen gas, serving as an inert gas 25, is filled in the cartridge so as to suppress generation of acids which inhibit conductivity in the fuel.

A continuous power generation test was performed with use of the fuel cartridge having the above configuration. After the display on the surface of the cartridge was ascertained not to be indicating “abnormal,” the fuel cartridge was attached to the fuel cell unit, and thereafter an electrical apparatus, such as a PC, was activated.

During use of the fuel cartridge, no great change was observed in power generation performance, and a stable output was obtained. Conductivity of the remaining fuel inside the fuel cartridge was measured and found to be 1 μS/cm or less; and metal ion concentration was measured by means of inductively coupled plasma spectrometry and found to be 100 ppb or less.

The fuel cartridge having the above shape was operated for about 1,800 hours. However, in a case where a fuel cartridge with a display not indicating “abnormal” was used, no drastic reduction in power generation performance was observed.

When the fuel cell system having the above configuration is employed, a metal ion concentration in the cartridge can be ascertained prior to or immediately after usage, thereby preventing degradation of the fuel cell system. Even when the fuel cell system is degraded, by virtue of sampling a solution in the cartridge and storing the same in the cartridge or in the unit, the cause for performance degradation of the system can be traced.

The present invention can provide a fuel cell system being capable of preventing supply, from a cartridge to the fuel cell system, of fuel into which metal ions are mixed, thereby preventing breakage which may be otherwise caused by the metal ions present inside the cartridge.

What is claimed is:

1. A fuel cell cartridge, filled with liquid fuel, comprising:
a warning mechanism including:
a detector to detect a concentration of metal ions in the liquid fuel; and
a comparator to compare the concentration of metal ions with a predetermined value, and
issuing a warning when the concentration of the metal ions exceeds the predetermined value.

2. The fuel cell cartridge according to claim 1, wherein
the warning is a visual or an audible signal.

3. The fuel cell cartridge according to claim 1, wherein
the warning mechanism includes:
a display section to display the liquid fuel; and
an indicator to be mixed with the liquid fuel,
the indicator reacts with the metal ions, thereby changing a color of the liquid fuel when the concentration of the metal ions exceeds the predetermined value.

4. The fuel cell cartridge according to claim 1, wherein
the warning mechanism includes;
a display section formed on a surface of the fuel cell cartridge;
a measurement section configured to perform measurement with regard to the liquid fuel; and
a calculation unit configured to calculate the concentration of the metal ions on a basis of a value obtained by the measurement section, and
the warning mechanism compares the concentration of the metal ions with the predetermined value, and issues a warning by means of providing an indication on the display section when the concentration of the metal ions exceeds the predetermined value.

5. The fuel cell cartridge according to claim 4, wherein
the measurement section measures conductivity.

6. The fuel cell cartridge according to claim 1, wherein
the warning mechanism includes:
a speaker;
a measurement section configured to perform measurement with regard to the liquid fuel; and
a calculation unit configured to calculate the concentration of the metal ions on a basis of a value obtained by the measurement section, and
the warning mechanism compares the concentration of the metal ions with the predetermined value, and issues a warning by means of causing the speaker to emit a sound when the concentration of the metal ions exceeds the predetermined value.

7. A fuel cell system comprising:
a fuel cell cartridge filled with liquid fuel; and
a fuel cell configured to receive supply of the liquid fuel from the fuel cell cartridge, to be activated, wherein
the fuel cell cartridge includes a warning mechanism including:
a detector to detect a concentration of metal ions in the liquid fuel; and
a comparator to compare the concentration of metal ions with a predetermined value, and
issuing a warning when the concentration of the metal ions exceeds the predetermined value.

8. The fuel cell system according to claim 7, wherein
the warning is a visual or an audible signal.

9. The fuel cell system according to claim 7, wherein
the warning mechanism causes an external apparatus to issue a warning.

10. The fuel cell system according to claim 7, wherein
the warning mechanism includes:
a display section formed on a surface of the fuel cell cartridge;
a measurement section configured to perform measurement with regard to the liquid fuel; and
a calculation unit configured to calculate the concentration of the metal ions on a basis of a value obtained by the measurement section, and
the warning mechanism compares the concentration of the metal ions with the predetermined value, and issues a warning by means of providing an indication on the display section when the concentration of the metal ions exceeds the predetermined value.

11. The fuel cell system according to claim 7, wherein
the measurement section measures conductivity.

12. The fuel cell system according to claim 7, wherein
the warning mechanism includes:
a speaker;
a measurement section configured to perform measurement with regard to the liquid fuel; and
a calculation unit configured to calculate the concentration of the metal ions on a basis of a value obtained by the measurement section, and
the warning mechanism compares the concentration of the metal ions with the predetermined value, and issues a warning by means of causing the speaker to emit a sound when the concentration of the metal ions exceeds the predetermined value.

13. A fuel cell system comprising:
a fuel cell cartridge filled with liquid fuel;
a fuel cell configured to receive supply of liquid fuel from the fuel cell cartridge, to be activated; and
a warning mechanism including;
a detector to detect a concentration of metal ions in the liquid fuel; and
a comparator to compare the concentration of metal ions with a predetermined value, and
issuing a warning when the concentration of the metal ions exceeds the predetermined value.
